(19) United States
(12) Patent Application Publication
(10) Pub. No.: US 2008/0266277 A1
(43) Pub. Date: Oct. 30, 2008

(54) METHOD OF DRIVING DISPLAY PANEL AND DRIVING DEVICE THEREOF

(76) Inventors: Hiroyoshi Ichikura, Ibaragi (JP); Naoya Kimura, Chiba (JP)

Correspondence Address: TAFT, STETTINIUS & HOLLISTER LLP, SUITE 1800, 425 WALNUT STREET, CINCINNATI, OH, 45202-3957, US

(21) Appl. No.: 12/102,049

(22) Filed: Apr. 14, 2008

(30) Foreign Application Priority Data
Apr. 26, 2007 (JP) JP 2007-116659

(51) Int. Cl. G09G 5/00

(52) U.S. Cl. 345/205

(57) ABSTRACT

Disclosed is a method and device of driving a display panel, which is capable of suppressing complexity and increase of circuit scale of the driving device, and performing a control to prevent a cathode reset method or a scanning operation from being performed when all anode data are black and thus prevent unnecessary parasitic capacitance from being pre-charged, which may result in alleviation of pseudo emission and reduction of power consumption. The driving device of the display panel includes an anode driver and a cathode driver connected to a display panel including EL elements arranged at intersections of a plurality of anode lines and a plurality of cathode lines. In a process of controlling the pre-charging of parasitic capacitance of the EL elements connected to a selected cathode line, when a “0” detecting means detects that all data of the plurality of anode lines are zero, a control mechanism switches all the cathode lines including the selected cathode line to “H” during a scanning period, based on a result of the detection.

### CROSS-REFERENCE TO RELATED APPLICATIONS

This application is a claims priority under 35 U.S.C. §119 to Japanese Patent Application Serial No. JP2007-116659 filed on Apr. 26, 2007, entitled “METHOD OF DRIVING DISPLAY PANEL AND DRIVING DEVICE THEREOF,” the disclosure of which is hereby incorporated by reference.

### BACKGROUND

The present invention relates to a method of driving a display panel using a light emitting element such as an organic electroluminescence element (hereinafter abbreviated as “EL element”), which is a self-luminous device, and a driving device thereof, and more particularly, to a cathode line scan (also referred to as “cathode sweeping”) in a full-charge method for parasitic capacitance of a light emitting element connected to a cathode line (also referred to as “scan line”).

In the related art, there has been proposed a method of driving a display panel using a light emitting element such as an EL device or a technique for a driving device thereof, for example, as disclosed in the following documents.

Japanese Patent Application Publication No. 2005-156859 discloses a driving device and a driving method of a self-luminous display panel. In the driving device of the passive drive type display panel in which the light emitting elements are arranged at respective intersecting positions of a plurality of anode lines (also referred to as “data lines”) and a plurality of cathode lines (also referred to as “scanning lines”) and drive current is selectively supplied from a current source to the light emitting elements corresponding to the cathode lines to be scanned via the anode lines, the current source is provided with a pre-charge current supply means for supplying constant current for charging parasitic capacitance of the light emitting elements to the light emitting elements and a drive current supply means for supplying constant current for performing light emission drive of the light emitting elements to the light emitting elements and performs the light emission drive of the light emitting elements whose voltage value between elements rises to a light emission threshold Vth by the constant current to be supplied from the pre-charge current supply means by the constant current to be supplied from the drive current supply means. With this configuration, while suppressing increase of circuit scale, gray scales can be exactly expressed by efficiently performing pre-charge to light emitting elements and securing light emittable time of the light emitting elements.

Japanese Patent Application Publication No. 2005-107004 also discloses a driving device and a driving method of a luminous display panel. This driving device of the luminous display panel includes a luminous display panel, a source driver and a gate driver for driving the luminous display panel, and a controller for controlling the source driver and the gate driver. With this configuration, in the case that all image data are, for example, non-luminous (data “0”) in one scanning period, one frame period, or a plurality of frame periods, the source driver is informed of all zeros from the controller through a signal line. Then the source driver forcibly outputs black data for respective pixels arrayed in the luminous display panel. Meanwhile, a timing signal or the like supplied from the controller to the source driver is stopped to set the source driver to a drive stop state. Since the gate driver executes scanning though drive of the source driver is stopped, pixels are displayed in black by output of black data from the source driver. Since the drive of the source driver operating at a high speed with a relatively high driving voltage is temporarily stopped in this manner, low power consumption can be realized.

FIG. 2 is a schematic circuit diagram showing an example of a configuration of the driving device of the conventional passive drive type display panel disclosed in Japanese Patent Application Publication No. 2005-156859 and such.

A passive drive type display panel 10 has a plurality of anode lines CL (CL0, CL1, CL2, . . . , CLm) and a plurality of cathode lines RL (RL0, RL1, RL2, . . . , RLn), which are arranged in the form of a matrix, and EL elements 11 (11-00, 11-01, . . . ), as self-luminous elements, arranged at respective intersecting positions of the plurality of anode lines and the plurality of cathode lines. The EL elements 11 are capacitive luminous elements replaceable with equivalent circuits, each of which is composed of a luminous element E such as a diode and parasitic capacitive Cp combined in parallel to the luminous element E.

In such a display panel 10, for example, with the anode lines CL as data lines and the cathode lines RL as scanning lines, a driving device for driving these anode lines CL and cathode lines RL has an anode driver 20 and a cathode driver 30.

The anode driver 20 has a plurality of constant current sources 21 (21-0, 21-2, . . . , 21-m) as driving sources operating under application of a power source voltage V1, and a plurality of drive switches 22 (22-0, 22-1, 22-2, . . . , 22-m) for selecting the respective anode lines CL. Each drive switch 22 switches the corresponding anode line CL between the corresponding constant current source 21 and a ground (hereinafter indicated by “GND”) by means of a light emission control circuit (not shown). The cathode driver 30 has a plurality of scanning switches 31 (31-0, 31-1, 31-2, . . . , 31-n) for scanning the cathode lines RL in turn, and each scanning switch 31 switches the corresponding cathode line RL between a reverse bias voltage V2 and the ground GND by means of the light emission control circuit (not shown).

In such a driving device, the cathode lines RL are selected and scanned in turn with certain time intervals by the light emission control circuit (not shown) and the anode lines CL are driven by the constant current supplied from the constant current source 21 in synchronization with the scanning, thereby causing EL elements 11 at any intersecting positions to emit light.

For example, when the EL element 11-00 at an intersecting position of the anode line CL0 and the cathode line RL0 is to emit light, first, the scanning switch 31-0 is switched to GND to scan the cathode line RL0. On the other hand, the constant current source 21-0 is connected to the anode line CL0 by the drive switch 22-0. In addition, a reverse bias voltage V2 is applied to other cathode lines RL1, RL2, . . . by the scanning switches 31-1, 31-2, . . . while other anode lines CL1, CL2, . . . are connected to GND by the drive switches 22-1, 22-2, . . . . Thus, only the EL element 11-00 is forward biased to emit light and other EL elements 11 do not emit light since they are not supplied with constant current from the constant current sources 21-1, 21-2, . . . .

When a light emission control voltage (driving voltage) is applied to the EL elements 11, first, charges corresponding to electric capacity of the EL elements 11 flow therein, as displacement current, and are accumulated in electrodes of the EL elements 11. When the light emission control voltage exceeds a certain voltage of the EL elements 11 (light emission threshold voltage, “Vth”), current begins to flow from the electrodes (anodes of the luminous elements E) from an organic layer composing a light emitting layer, thereby emitting light with intensity (luminance) in substantial proportion to this current (driving current).

For example, as disclosed in Japanese Patent Application Publication No. 2005-156859, static characteristics of the EL elements 11 may include the following (1) and (2).

(1) The EL elements 11 emit light with luminance Lt in substantial proportion to driving current I.

(2) The EL elements 11 emit light as current I abruptly flows in the EL elements 11 when the driving voltage V exceeds the light emission threshold voltage Vth. On the contrary, when the driving voltage V is smaller than the light emission threshold voltage Vth, current does not mostly flow in the EL elements 11 without emission. In a light emittable region having the driving voltage V larger than the light emission threshold voltage Vth, the EL elements 11 has a luminance characteristic that the luminance Lt becomes larger as the driving voltage V applied to the region becomes increased.

For the passive drive type display panel 10 of such EL elements 11, there is a temporal gray scale control method as one of methods for representation of gray scales. A temporal gray scale control method refers to a method of representing gray scales by driving the EL elements 11 by constant current for emission and controlling emission time at specified intervals. However, this temporal gray scale control method has the following problem due to the capacitance of the EL elements 11 as mentioned above.

In a passive driving, first, since the EL elements 11 begin to emit light after charges are accumulated as displacement current in the parasitic capacitance Cp of the EL elements 11, if charging of the parasitic capacitance Cp of the EL elements 11 (referred to as “pre-charge”) is not performed, it may take a time to rise from an element voltage of the EL elements 11 up to the light emission threshold voltage Vth, which may result in insufficient emission of the EL elements 11. Accordingly, in the temporal gray scale control method, the pre-charge is performed for the parasitic capacitance Cp of the EL elements 11 by supplying a constant voltage or a constant current immediately to the EL elements 11 using a cathode reset method or the like before the EL elements 11 begin to emit light.

FIGS. 3A to 3D are views showing an operation of a cathode reset method in the conventional driving device shown in FIG. 2 and disclosed in Japanese Patent Application Publication No. 2005-156859 and such: FIG. 3A showing a lighting state, FIG. 3B showing a reset state, FIG. 3C showing a pre-charge state, and FIG. 3D showing a lighting state. FIG. 4 is a schematic timing chart of the cathode reset method shown in FIGS. 3A to 3D, where t0 represents a reset start time of FIG. 3B and t1 represents a time near pre-charge start and end of FIG. 3C which are performed in a short time after the reset end of FIG. 3B.

In the display panel 10 of FIG. 2, for example, a cathode operation from a state of FIG. 3A, where the EL element 11-00 is connected to the anode line CL0 and the cathode line RL0 is driven to emit light, to a state of FIG. 3D, where the EL element 11-01 is connected to the anode line CL0 and the cathode line RL1 is driven to emit light in the next scanning, will be described.

In the lighting state of FIG. 3A, when the EL element 11-00 is driven to emit light, the drive switch 22-0 of the anode driver 20 is switched to a high level (hereinafter referred to “H”) of the constant current source 21-0 and the scanning switch 31-0 of the cathode driver 30 is switched to a low level (hereinafter referred to “L”) of GND to scan the cathode line RL0, while other scanning switches 31-1 to 31-n are switched to “H” of the reverse bias voltage V2 to turn the cathode lines RL1 to RLn into a non-scanned state. The driving current flows along a path of the constant current source 21-0, through the drive switch 22-0, through the anode line CL0, through the EL element 11-00, through the cathode line RL0, through the scanning switch 31-0 to GND, thereby causing the EL element 11-00 to emit light and charging the parasitic capacitance Cp.

In the reset state of FIG. 3B (time to of FIG. 4), when all the drive switches 22-0 to 22-m (all the anode lines CL0 to CLm) and all the scanning switches 31-0 to 31-n (the cathode lines RL0 to RLn) are switched to “L” of GND (in addition, all the drive switches 22-0 to 22-m may be switched to GND before time t0), charges accumulated in the parasitic capacitance Cp of each EL element 11-00 to 11-0n are discharged along a path of the cathode lines RL0 to RLn, through the scanning switches 31-0 to 31-n to GND. In addition, charges accumulated in wiring capacitance of the anode line CL0 and the like are discharged along a path of the drive switch 22-0 to GND, thereby ending the reset operation (before time t1 of FIG. 4).

In the pre-charge state of FIG. 3C (near immediately before time t1 of FIG. 4), in order to pre-charge the EL element 11-01 by scanning the next cathode line RL1, all the drive switches 22-0 to 22-m (all the anode lines CL0 to CLm) are switched to “H” of the constant current sources 21-0 to 21-m, and, with only the scanning switch 31-1 (the cathode line RL1) remaining in “L” of GND, other scanning switches 31-0 and 31-2 to 31-n (the cathode lines RL0 and RL2 to RLn) are switched to “H” of the reverse bias voltage V2.

Thus, in a short time, the driving current flows along a path of the constant current source 21-0, through the drive switch 22-0, through the anode line CL0, through the parasitic capacitance Cp of the EL element 11-01, through the cathode line RL1, through the scanning switch 31-1 to GND, while charges accumulated in the parasitic capacitance Cp of other EL elements 11-00 and 11-02 to 11-n are discharged along a path of the anode line CL0, through the parasitic capacitance Cp of the EL element 11-01, through the cathode line RL1, through the scanning switch 31-1 to GND. Accordingly, the parasitic capacitance Cp of the EL element 11-01 to emit light next is suddenly pre-charged (near time t1 of FIG. 4).

Thereafter, in the lighting state of FIG. 3D, a forward voltage of the EL element 11-01 is instantaneously produced by the driving current supplied from the constant current source 21-0 to the anode line CL0, thereby causing the EL element 11-01 to emit light.

However, the cathode reset method of the driving device of the conventional passive drive type display panel has the following problems (a) to (c).

(a) As cathode lines RL other than a cathode line RL to be scanned (hereinafter referred to as “scan line”) are simultaneously changed to “H” of an output of the cathode drive, excessive charges of the parasitic capacitance other than a constant current driving voltage flow into the scan line, thereby pre-charging the parasitic capacitance to be suddenly driven. By the way, for black display, due to rising of a potential of the anode line CL that should not inherently become “H,” current flows instantaneously into the anode driver 20 that should not be driven, which causes a problem of pseudo emission, i.e., thin glittering of black display.

(b) Although there is a method of driving the driving device with a voltage of the cathode driver 30, which is lower than a voltage of the anode driver 20 and does not exceed a threshold voltage Vth, this method needs to generate a separate voltage, which causes a problem of more complicated circuit configuration and increased circuit scale of the driving device.

(c) Neither the method (a) nor (b) can control setting of a pre-charge voltage of the parasitic capacitance of the EL elements 11 to a required voltage or current, or if possible, these methods also cause a problem of complexity and increased circuit scale of the driving device.

### SUMMARY

According to an aspect of the invention, there is provided a driving method of a display panel in which display elements are arranged at intersections of a plurality of data lines and a plurality of scan lines, and the display elements are lit when an output voltage of a data line driving circuit is applied to the data lines and a scan line driving circuit switches the scan lines from “H” to “L” and flows a driving current from the data lines to the scan lines through the display elements. In a process of pre-charging parasitic capacitance of the display elements connected to a selected one of the scan lines, when it is detected that all data of the plurality of data lines are zero, all the scan lines including the selected scan line are switched to “H” during scanning time of the scan lines.

According to another aspect of the invention, there is provided a driving device of a display panel in which display elements are arranged at intersections of a plurality of data lines and a plurality of scan lines, including: a data line driving circuit that flows a driving current to the display elements by applying an output voltage to the data lines for lighting of the display elements and switches the data lines to a “L” terminal for non-lighting of the display elements; a scan line driving circuit that switches the scan lines from “H” to “L” for selection of the scan lines and switches the scan lines from “L” to “H” for non-selection of the scan lines; a detecting unit that detects that all data of the plurality of data lines are zero in a process of pre-charging parasitic capacitance of the display elements connected to a selected one of the scan lines; and a control unit that switches all the scan lines including the selected scan line to “H” during scanning time of the scan lines based on a result of detection of the detecting unit in the process of pre-charging.

According to the driving method and device of the display panel of the present invention, in a cathode reset method, since the driving device includes the detecting unit that detects logic “0” of all data of the plurality of data lines, and the control unit that causes the scan line driving circuit to switch all the scan lines including the selected scan line to “H” during scanning time of the scan lines based on a result of the detection, it is possible to perform a control to prevent the cathode reset method or the scanning operation from being performed when all the anode data are black and thus prevent unnecessary parasitic capacitance from being pre-charged, which may result in alleviation of pseudo emission and reduction of power consumption, while suppressing complexity and increase of circuit scale of the driving device.

### BRIEF DESCRIPTION OF THE DRAWINGS

FIG. 1 is an exemplary schematic view showing a configuration of a driving device of a passive drive type display panel according to Embodiment 1 of the present invention.

FIG. 2 is a schematic view showing an example configuration of a prior art driving device of a passive drive type display panel.

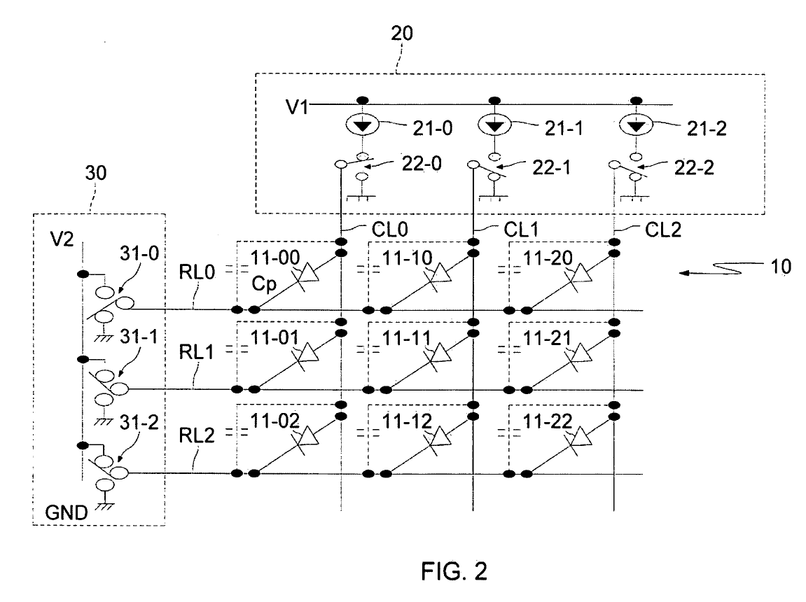

FIGS. 3A to 3D are views showing an operation of a cathode reset method in the conventional driving device shown in FIG. 2.

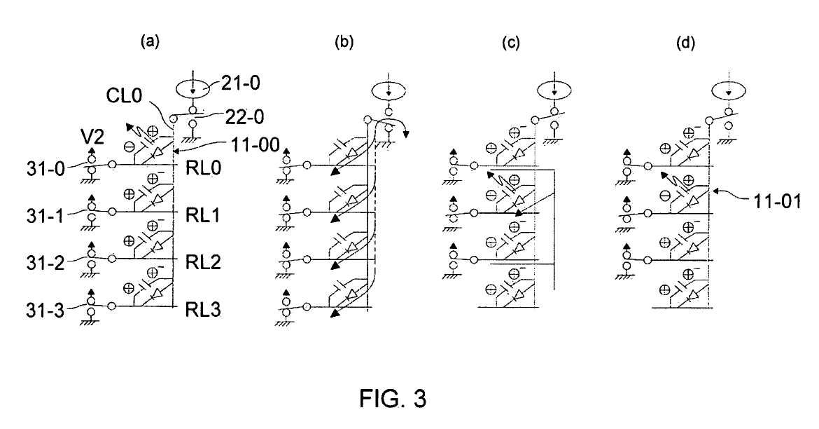

FIG. 4 is a schematic timing chart of the cathode reset method shown in FIGS. 3A to 3D.

FIG. 5 is a schematic timing chart for explaining a cathode operation of anode voltage control in a cathode reset method of the driving device shown in FIG. 1.

FIG. 6 is a timing chart for explaining a cathode reset method control operation for anode data “0” of FIG. 1.

### DETAILED DESCRIPTION

According to exemplary embodiments of the present invention, a driving device of a display panel includes an anode driver and a cathode driver connected to the display panel including EL elements arranged at intersections of a plurality of anode lines and a plurality of cathode lines. The anode driver applies an output voltage to the anode lines to flow a driving current in the EL elements for lighting of the EL elements and switches the anode lines to “L” for non-lighting of the EL elements. The cathode driver switches the cathode lines from “H” to “L” for selection of the cathode lines and switches the cathode lines from “L” to “H” for non-selection of the cathode lines. In a process of controlling the pre-charging of parasitic capacitance of the EL elements connected to a selected cathode line, a “0” detecting mechanism detects that all data of the plurality of anode lines are zero. Based on the result of detection, a control mechanism switches all the cathode lines including the selected cathode line to “H” during a scanning period of time of the cathode lines RL.

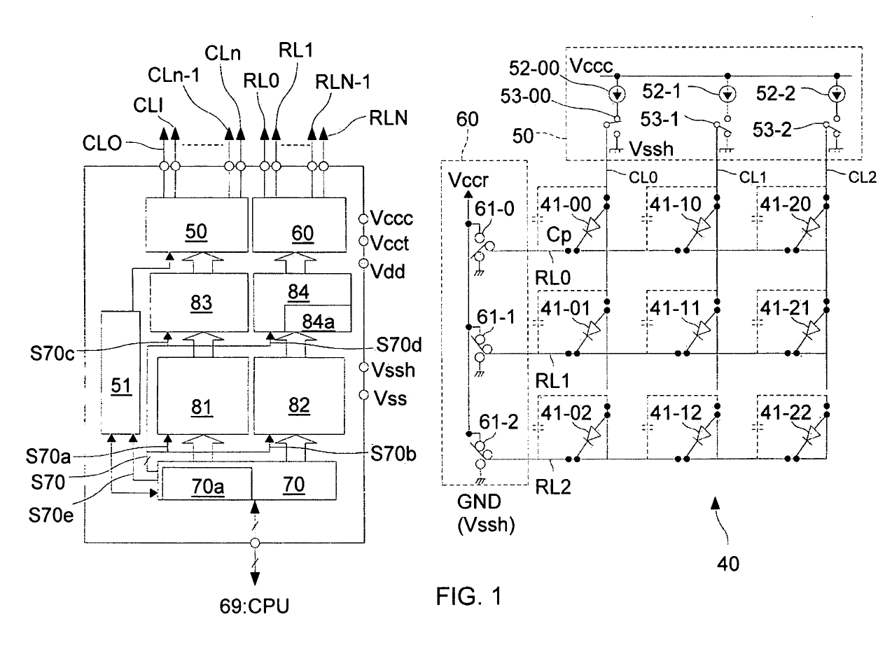

FIG. 1 is a schematic view showing a configuration of a driving device of a passive drive type display panel according to a first embodiment of the present invention.

A passive drive type display panel 40 has a plurality of anode lines CL (CL0, CL1, CL2, . . . , CLm−1, CLm) and a plurality of cathode lines RL (RL0, RL1, RL2, RLn−1, RLn), which are arranged in the form of a matrix, and EL elements 41 (41-00, 41-01, . . . ), as self-luminous elements, arranged at respective intersecting positions of the plurality of anode lines and the plurality of cathode lines. In an equivalent circuit, parasitic capacitive Cp is combined in parallel to each EL element 41.

In such a display panel 40, for example, with the anode lines CL as data lines and the cathode lines RL as scanning lines, a driving device for driving these anode lines CL and cathode lines RL has an anode driver 50 as a data line driving circuit and a cathode driver 60 as a scanning line driving circuit.

The anode driver 50 has a constant current circuit 51 as a driving source operating under application of a power source voltage Vccc and a plurality of drive switches 53 (53-0, 53-1, 53-2, . . . , 53-m−1, 53-m) for selecting the respective anode lines CL. The constant current circuit 51 is composed of a plurality of constant current sources 52 (52-0, 52-1, 52-2, . . . , 52-m−1, 52-m). Each drive switch 53 is a switch element for switching between each anode line CL and each constant current source 52 or GND of a ground voltage Vssh by a timing control circuit 70, an anode data transmission circuit 81 and an anode driver control circuit 83.

The cathode driver 60 has a plurality of scanning switches 61 (61-0, 61-1, 61-2, 61-n−1, 61-n) for scanning the cathode lines RL in turn, and each scanning switch 61 is a switch element for switching each cathode line RL between a reverse bias voltage Vccr or GND of the ground voltage Vssh by the timing control circuit 70, a cathode data transmission circuit 82 and a cathode driver control circuit 84.

In addition, FIG. 1 shows a block diagram representation of the anode driver 50, the constant current circuit 51 and the cathode driver 60 in the left side of the figure and a circuit diagram of their respective circuit diagrams in the right side of the figure for the sake of convenience of ease viewing of the figure.

The timing control circuit 70 is a circuit that exchanges control signals and such with a control circuit (for example, a central processing unit (“CPU”, not shown)) via a CPU interface 69 to the control circuit, outputs a plurality of cathode control signals S70 and various timing signals such as pre-charge timings, temporal gray scale timings and the like and generates an image by means of an internal control mechanism (not shown) and a detecting mechanism (for example, a “0,” detecting mechanism) 70a for detecting logic “0” at which all anode data become black. The timing control circuit 70 is connected with the constant current circuit 51 for controlling timings, the anode data transmission circuit 81, the cathode data transmission circuit 82, the anode driver control circuit 83 and the cathode driver control circuit 84. The plurality of cathode control signals S70 include, for example, a control signal S70a for the anode data transmission circuit 81, a control signal S70b for the cathode data transmission circuit 82, a control signal S70c for the anode driver control circuit 83, a control signal S70d for the cathode driver control circuit 84, and a control signal S70c for the constant current circuit 51.

The anode data transmission circuit 81 is a circuit that is input with the control signal S70a supplied from the timing control circuit 70, anode data and such, receives the anode data and such in an internal latch circuit, and transmits the anode data and such through an internal shift register or the like. The anode driver control circuit 83 is connected to an output side of this circuit 81. The cathode data transmission circuit 82 is a circuit that is input with the control signal S70b supplied from the timing control circuit 70, cathode line scanning data and such, receives the cathode line scanning data and such in an internal latch circuit, and transmits the cathode line scanning data and such through an internal shift register or the like. The cathode driver control circuit 84 is connected to an output side of this circuit 82.

The anode driver control circuit 83 is a circuit that is input with the control signal S70c supplied from the timing control circuit 70 and the anode data and such supplied from the anode data transmission circuit 81 and controls discharge, pre-charge, gray scale timings and such of the anode driver 50. The cathode driver control circuit 84 is a circuit that is input with the control signal S70d supplied from the timing control circuit 70 and the cathode line scanning data and such supplied from the cathode data transmission circuit 82 and controls discharge, pre-charge, sweeping discharge, non-sweeping timings and such of the cathode driver 60. The cathode driver control circuit 84 contains a control means 84a that causes the cathode driver 60 to set all the cathode lines including a scan line to be “H” during time of the scan line based on the result of detection of the “0” detecting means 70a in the timing control circuit 70.

A power source voltage Vdd and a ground voltage Vss for driving are applied to the timing control circuit 70, the anode data transmission circuit 81, the cathode data transmission circuit 82, the anode driver control circuit 83 and the cathode driver control circuit 84.

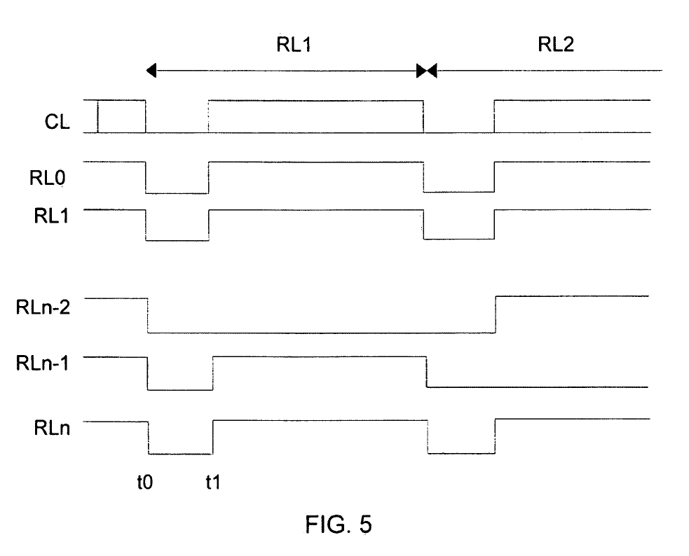

FIG. 5 is a schematic timing chart for explaining a cathode operation of anode voltage control in a cathode reset method of the driving device shown in FIG. 1, where t0 represents a reset start time and t1 represents a time near pre-charge start and end which are performed in a short time after the reset end.

In the display panel 40 of FIG. 1, for example, a cathode operation from a state where the EL element 41-00 connected to the anode line CL0 and the cathode line RL0 is driven to emit light to a state where the EL element 41-01 connected to the anode line CL0 and the cathode line RL1 is driven to emit light in the next scanning will be described.

In driving the display panel 40, data and control signals sent from a CPU (not shown) are input to the timing control circuit 70 via the CPU interface 69. The timing control circuit 70 performs an entire timing control of the driving device by outputting the cathode control signals S70 (S70a to S70e) and various timing signals such as pre-charge timings, temporal gray scale timings and the like and performing an image.

Of the anode data and the cathode data output from the timing control circuit 70, the anode data and such are transmitted to the anode driver control circuit 83 through the anode data transmission circuit 81, and the anode driver control circuit 83 performs a switching control of the drive switches 53-0 to 53-m of the anode driver 50. The cathode data and such output from the timing control circuit 70 are transmitted to the cathode driver control circuit 84 through the cathode data transmission circuit 82, and the cathode driver control circuit 84 performs a switching control of the scanning switches 61-0 to 61-n of the cathode driver 60. In addition, a driving current is output from the constant current sources 52-0 to 52-m by the constant current circuit 51 whose timing is controlled by the timing control circuit 70.

For example, in the lighting state of FIG. 1, when the EL element 41-00 is driven to emit light, the drive switch 53-0 (the anode line CL0) of the anode driver 50 is switched to “H” of the constant current source 52-0 and the scanning switch 61-0 (the cathode line RL0) of the cathode driver 60 is switched to “L” of GND to scan the cathode line RL0, while other scanning switches 61-1 to 61-n (the cathode lines RL1 to RLn) are switched to “H” of the reverse bias voltage Vccr to turn the cathode lines RL1 to RLn into a non-scanned state. Accordingly, the driving current flows along a path of the constant current source 52-0, through the drive switch 53-0, through the anode line CL0, through the EL element 41-00, through the cathode line RL0, through the scanning switch 61-0 to GND, thereby causing the EL element 41-00 to emit light and charging the parasitic capacitance Cp.

In the reset state of FIG. 1 (time t0 of FIG. 5), according to the control of the cathode control signal S70 output from the timing control circuit 70, all the drive switches 53-0 to 53-m (all the anode lines CL0 to CLm) are switched to “L” of GND, while only L (2≦L<n+1) scanning switches 61 (the cathode lines RL) including the scanning switch 61-1 (the cathode line RL1) of all the scanning switches 61-0 to 61-n are switched to “L” of GND, and charges accumulated in the parasitic capacitance Cp of the EL elements 41 connected thereto are discharged to GND via the L scanning switches 61. In addition, charges accumulated in wiring capacitance of the anode line CL0 and the like are discharged along a path of the drive switch 53-0 to GND, thereby ending the reset operation (before time t1 of FIG. 5). In addition, all the drive switches 53-0 to 53-m may be switched to GND before time t0),

In the pre-charge state of FIG. 1 (near immediately before time t1 of FIG. 5), in order to cause the EL element 41-01 by scanning the next cathode line RL2, the drive switch 53-0 is switched to “H” of the constant current source 52-0, and, according to the control of the cathode control signal S70 output from the timing control circuit 70, with only L (2≦L<n+1) scanning switches 61 (the cathode lines RL), including the scanning switch 61-1 (the cathode line RL1) of all the scanning switches 61-0 to 61-n, switched to “L” of GND, other (n+1−L) scanning switch 61 are switched to “H” of the reverse bias voltage Vccr. Thus, in a short time, the driving current flows along a path of the constant current source 53-0, through the drive switch 53-0, through the anode line CL0, through the parasitic capacitance Cp of the EL element 41-01, through the cathode line RL1, through the scanning switch 61-1 to GND, while charges accumulated in the parasitic capacitance Cp of other (L−1)_EL elements 41-00, . . . are discharged along a path of the anode line CL0, through the parasitic capacitance Cp of the EL element 41-01, through the cathode line RL1, through the scanning switch 61-1 to GND. Accordingly, the parasitic capacitance Cp of the EL element 41-01 to emit light next is suddenly pre-charged (near time t1 of FIG. 5).

Thereafter, in the lighting state of FIG. 1, a forward voltage of the EL element 41-01 is instantaneously produced by the driving current supplied from the constant current source 52-0 to the anode line CL0, thereby causing the EL element 41-01 to emit light.

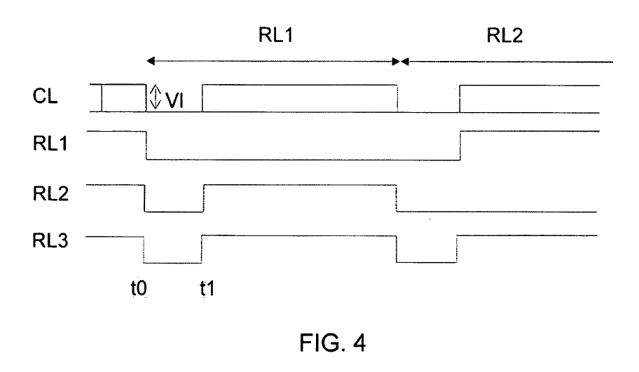

As described above, in setting the cathode reset method, as shown in FIG. 4, by providing control or data signals to cause the cathode driver RL to be “H” or “L” to the timing control circuit 70 and the cathode data transmission circuit 82 or the cathode driver control circuit 84 via the CPU interface 69 and setting both of outputs of the cathode driver 60 and the anode driver 50 to be “L” simultaneously, a pre-charge operation of the parasitic capacitance is performed. Through such a control, an anode output voltage at output start of the anode driver 50 is set near an anode driving voltage Vf, as shown in FIG. 4.

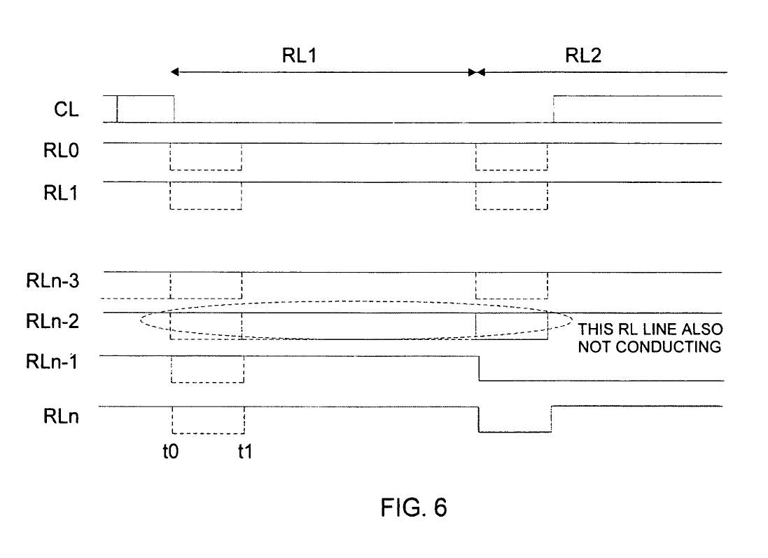

FIG. 6 is a timing chart for explaining a cathode reset method control operation for anode data “0” of FIG. 1.

In the cathode reset method, when all the anode data are “0”, i.e., black at reset start of time to, reset end before time t1, and pre-charge near time t1, by asserting (validating) the “0” detecting mechanism 70a in the timing control circuit 70, all the cathode lines including a scan line which is an output of the cathode driver 60 are set to be “H” during time of the scan line by means of the control means 84a in the cathode driver control circuit 84.

According to the first embodiment as described above, it is configured that, when all the anode data are “0”, i.e., black, by utilizing the “0” detecting mechanism 70a in the timing control circuit 70, all the cathode lines including a scan line which is an output of the cathode driver 60 are set to be “H” during the scan time of the scan line by means of the control mechanism 84a in the cathode driver control circuit 84. With this configuration, while suppressing complexity and increase of circuit scale of the driving device, it is possible to perform a control to prevent the cathode reset method or the scanning operation from being performed when all the anode data are black and thus prevent unnecessary parasitic capacitance from being pre-charged, which may result in alleviation of pseudo emission and reduction of power consumption.

The present invention is not limited to the above embodiment but may be modified and used in various ways. Without limitation, examples of various modifications and uses may include the following (A) and (B).

(A) The “0” detecting mechanism 70a of Embodiment 1 may be provided and asserted in the anode data transmission circuit 81 or the anode driver control circuit 83 instead of the timing control circuit 70. Alternatively, it may be configured that the control mechanism 84a is provided in the timing control circuit 70 or the cathode data transmission circuit 82 instead of the cathode driver control circuit 84 and all the cathode lines including a scan line which is an output of the cathode driver 60 are set to be “H” during the scan time of the scan line by means of the timing control circuit 70 or the cathode data transmission circuit 82. This can have substantially the same operation and effects as Embodiment 1.

(B) Although it has been illustrated in Embodiment 1 that the present invention is applied to the driving device of the display panel using the EL elements 41, the present invention can be also applied to a driving device of other flat panels such as flat liquid crystal display (LCD) panels.

Following from the above description and invention summaries, it should be apparent to those of ordinary skill in the art that, while the methods and apparatuses herein described constitute exemplary embodiments of the present invention, the invention contained herein is not limited to this precise embodiment and that changes may be made to such embodiments without departing from the scope of the invention as defined by the claims. Additionally, it is to be understood that the invention is defined by the claims and it is not intended that any limitations or elements describing the exemplary embodiments set forth herein are to be incorporated into the interpretation of any claim element unless such limitation or element is explicitly stated. Likewise, it is to be understood that it is not necessary to meet any or all of the identified advantages or objects of the invention disclosed herein in order to fall within the scope of any claims, since the invention is defined by the claims and since inherent and/or unforeseen advantages of the present invention may exist even though they may not have been explicitly discussed herein.

What is claimed is:

1. A method for driving a display panel, the display panel including a plurality of display elements arranged at intersections of a plurality of data lines and a plurality of scan lines, and a display element is lit when an output voltage of a data line driving circuit is applied to a data line corresponding to the display element and a scan line driving circuit switches a scan line corresponding to the display element from a high potential level to a low potent level and flows a driving current from the data line to the scan line through the display element, the method including the steps of:
in a process that includes the control of pre-charging parasitic capacitance of the display elements connected to a selected one of the scan lines, detecting whether all of the data to be provided on the plurality of data lines corresponding to the selected one of the scan lines are zeros; and
responsive to the detection that all of the data to be provided on the plurality of data lines corresponding to the selected one of the scan lines are zeros, switching all of the scan lines, including the selected one of the scan lines, to the high potential during a scanning period of the selected one of the scan lines thereby preventing the pre-charging of the parasitic capacitance of the display elements connected to the selected one of the scan lines.

2. The method according to claim 1, wherein the display elements are light emitting elements including organic electroluminescence elements.

3. A driving device of a display panel in which display elements are arranged at intersections of a plurality of data lines and a plurality of scan lines, comprising:
a data line driving circuit that provides a driving current to the display elements by applying an output voltage to the data lines for lighting of the display elements and switches the data lines to a low potential terminal for non-lighting of the display elements;
a scan line driving circuit that switches the scan lines from a high potential level to a low potential level for selection of the scan lines and switches the scan lines from the low potential level to the high potential level for non-selection of the scan lines;
a detecting unit configured to detect whether all data of the plurality of data lines are to be zero in a process of controlling a pre-charge of parasitic capacitance of the display elements connected to a selected one of the scan lines; and
a control unit configured to switch all the scan lines including the selected one of scan lines to the high potential level during scanning period of the selected one of the scan lines based on a result of detecting by the detecting unit that all data of the plurality of data lines are to be zero in the process of controlling the pre-charge of parasitic capacitance of the display elements connected to the selected one of the scan lines.

4. The driving device according to claim 3, wherein the display elements are light emitting elements including organic electroluminescence elements.

5. The driving device according to claim 4, further comprising:
a timing control circuit;
wherein the scan line driving circuit includes,
a cathode driver having a plurality of scanning switches for switching the scan lines between a high potential level and a low potential level;
a cathode data transmission circuit, operatively coupled to the timing control circuit for receiving control signals and cathode line scanning data therefrom; and
a cathode driver control circuit operatively coupled between the cathode data transmission circuit and the cathode driver for receiving cathode line scanning data from the cathode data transmission circuit and controlling the switching of scanning switches of the cathode driver;
wherein the data line driving circuit includes,
an anode driver having a plurality of driver switches for switching the data lines between the output voltage and the low potential;
an anode data transmission circuit, operatively coupled to the timing control circuit for receiving control signals and anode data therefrom; and
an anode driver control circuit operatively coupled between the anode data transmission circuit and the anode driver for receiving anode data from the anode data transmission circuit and controlling the switching of the driver switches of the anode driver; and
wherein the timing control circuit includes the detecting unit and the cathode driver control circuit includes the control unit.

6. The driving device according to claim 4, further comprising:
a timing control circuit;
wherein the scan line driving circuit includes,
a cathode driver having a plurality of scanning switches for switching the scan lines between a high potential level and a low potential level;
a cathode data transmission circuit, operatively coupled to the timing control circuit for receiving control signals and cathode line scanning data therefrom; and
a cathode driver control circuit operatively coupled between the cathode data transmission circuit and the cathode driver for receiving cathode line scanning data from the cathode data transmission circuit and controlling the switching of scanning switches of the cathode driver;
wherein the data line driving circuit includes,
an anode driver having a plurality of driver switches for switching the data lines between the output voltage and the low potential;
an anode data transmission circuit, operatively coupled to the timing control circuit for receiving control signals and anode data therefrom; and
an anode driver control circuit operatively coupled between the anode data transmission circuit and the anode driver for receiving anode data from the anode data transmission circuit and controlling the switching of the driver switches of the anode driver;
wherein the detecting unit is provided by one or more of the timing control circuit, the anode data transmission circuit and the anode driver control circuit; and
wherein the control unit is provided by one or more of the timing control circuit, the cathode data transmission circuit and the cathode driver control circuit.

7. A driving device of a display panel in which display elements are arranged at intersections of a plurality of data lines and a plurality of scan lines, comprising:
a data line driving circuit that provides a driving current to the display elements by applying an output voltage to the data lines for lighting of the display elements and switches the data lines to a low potential terminal for non-lighting of the display elements;
a scan line driving circuit that switches the scan lines from a high potential level to a low potential level for selection of the scan lines and switches the scan lines from the low potential level to the high potential level for non-selection of the scan lines;
means for detecting whether all data for the plurality of data lines are to be zero in a process of controlling a pre-charge of parasitic capacitance of the display elements connected to a selected one of the scan lines; and
means for switching all the scan lines including the selected one of scan lines to the high potential level during scanning period of the selected one of the scan lines as a result of the detecting means detecting that all data for the plurality of data lines are to be zero in the process of controlling the pre-charge of parasitic capacitance of the display elements connected to the selected one of the scan lines.

8. The driving device according to claim 7, wherein the display elements are light emitting elements including organic electroluminescence elements.
